(19) United States
(12) Patent Application Publication
(10) Pub. No.: US 2023/0102954 A1
(43) Pub. Date: Mar. 30, 2023

(54) AUTOMATIC EVALUATION OF WHEAT RESISTANCE TO FUSARIUM HEAD BLIGHT USING DUAL MASK

(71) Applicant: Regents of the University of Minnesota, Minneapolis, MN (US)

(72) Inventors: Ce Yang, Minneapolis, MN (US); Brian Steffenson, Minneapolis, MN (US)

(21) Appl. No.: 17/933,283

(22) Filed: Sep. 19, 2022

Related U.S. Application Data
(60) Provisional application No. 63/249,772, filed on Sep. 29, 2021.

(51) Int. Cl. G06V 10/75; G06T 7/00; G06T 7/11

(52) U.S. Cl. CPC G06V 10/751; G06T 7/0012; G06T 7/11; G06T 2207/20084; G06T 2207/20081

(57) ABSTRACT

A method includes applying an image containing a plurality of wheat spikes to a trained neural network to produce a plurality of sub-images, each sub-image comprising a respective single wheat spike segmented from other wheat spikes of the plurality of wheat spikes. Each sub-image is applied to a second trained neural network to produce at least one disease pixel set, wherein each disease pixel set consists of pixels depicting a diseased portion of a wheat spike.

### CROSS-REFERENCE TO RELATED APPLICATION

The present application is based on and claims the benefit of U.S. provisional patent application Ser. No. 63/249,772, filed Sep. 29, 2021, the content of which is hereby incorporated by reference in its entirety.

This invention was made with government support under 58-5062-8-018 awarded by the USDA. The government has certain rights in the invention.

### BACKGROUND

Wheat (Triticum aestivum L.) is a globally significant crop for human and animal consumption. In the United States, wheat plays an important role in promoting export markets and trade balances in addition to meeting domestic food and feed production needs. Many diseases affect wheat production and threaten global food security. One of the most devastating fungal diseases attacking wheat is Fusarium head blight (FHB), caused primarily by Fusarium graminearum. FHB attacks the spikes (ears) of wheat, causing marked reductions in both the yield and quality of the crop. Moreover, the fungus can produce an array of mycotoxins (e.g., deoxynivalenol or DON) within the grain rendering it unsuitable for human or animal consumption. Thus, FHB can severely impact public health in addition to reducing the yield and quality of the crop. Spikelets infected with FHB show premature bleaching. In a susceptible wheat line, infection of just a single spikelet can eventually spread across the entire spike. The breeding of FHB resistant cultivars is one of the most important means for ameliorating the impact of this disease. To develop resistant cultivars, hundreds of breeding lines must be evaluated for FHB severity each year, often at multiple field sites.

The discussion above is merely provided for general background information and is not intended to be used as an aid in determining the scope of the claimed subject matter. The claimed subject matter is not limited to implementations that solve any or all disadvantages noted in the background.

### SUMMARY

A method includes applying an image containing a plurality of wheat spikes to a trained neural network to produce a plurality of sub-images, each sub-image comprising a respective single wheat spike segmented from other wheat spikes of the plurality of wheat spikes. Each sub-image is applied to a second trained neural network to produce at least one disease pixel set, wherein each disease pixel set consists of pixels depicting a diseased portion of a wheat spike.

In accordance with a further embodiment, a system includes a processor executing a first neural network that receives an image of a field and produces a plurality of sub-images, each sub-image providing a respective wheat spike in isolation. At least one processor executes a second neural network that receives a sub-image and identifies pixels in the sub-image that represent diseased portions of the wheat spike in the sub-image.

In accordance with a still further embodiment, a method includes segmenting wheat spikes in an image to form a plurality of sub-images and applying each sub-image to a deep learning system to identify pixels in the sub-image that depict a diseased area of the wheat spike. The identified pixels are then used to produce a measure of disease in wheat spikes contained in the image.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A is an example of a typical full-size image of spikes from a single planted row of wheat in a field.

FIG. 1B is the image of FIG. 1A with annotated wheat spikes.

FIG. 1C is a segmented sub-image of a single wheat spike.

FIG. 1D shows the individual wheat spike of FIG. 1C with annotated diseased areas.

FIG. 2 is an architecture of the mask region convolutional neural network (Mask-RCNN) approach for wheat Fusarium head blight (FHB) disease assessment in accordance with one embodiment.

FIG. 3 is a flowchart of the proposed approach for evaluating FHB disease severity in accordance with one embodiment.

FIG. 4A shows training curves of accuracy and loss against the number of iterations on identifications of wheat spike.

FIG. 4B shows training curves of accuracy and loss against the number of iterations on identifications of diseased areas.

FIG. 5A shows an original image (left) and a corresponding recognition result (right) of an instance segmentation on correct detections of wheat spikes with a high density of wheat spikes.

FIG. 5B shows an original image (left) and a corresponding recognition result (right) of an instance segmentation on correct detections of wheat spikes with overlapping boundaries.

FIG. 5C shows an original image (left) and a corresponding recognition result (right) of an instance segmentation on correct detections of wheat spikes cut at the image borders.

FIG. 6A shows an individual wheat spike (I) in isolation, detected disease areas in the wheat spike (II) and the diseased area segmented from the wheat spike (III) when the diseased area has a shadow.

FIG. 6B shows an individual wheat spike (I) in isolation, detected disease areas in the wheat spike (II) and the diseased areas segmented from the wheat spike (III) when the diseased areas are under strong light.

FIG. 6(c) shows an individual wheat spike (I) in isolation, detected disease areas in the wheat spike (II) and the diseased area segmented from the wheat spike (III) when the diseased areas are under low light.

FIG. 6D shows an individual wheat spike (I) in isolation, detected disease areas in the wheat spike (II) and the diseased area segmented from the wheat spike (III) when the diseased areas are under awn occlusion.

FIG. 6E shows an individual wheat spike (I) in isolation, detected disease areas in the wheat spike (II) and the diseased area segmented from the wheat spike (III) when the diseased areas are under awn occlusion.

FIG. 7A a selected example of an original image with multiple wheat spikes.

FIG. 7B a zoom-in view of a spike of FIG. 7A occluded by a peduncle.

FIG. 7(c) shows the results of Mask-RCNN for wheat spike segmentation of the spike of FIG. 7B.

FIG. 7D shows the results of Mask-RCNN for disease area identification in the wheat spike of FIG. 7C.

FIG. 7E shows the result of segmenting diseased spikelets.

FIG. 8A is a graph of the number of wheat spikes at different disease grades in a training set.

FIG. 8B is a graph of the number of predicted and ground truth spikes in a validation set.

FIG. 9 is a block diagram of a system for determining disease severity in accordance with one embodiment.

FIG. 10 is a block diagram of a system for determining disease severity in accordance with a further embodiment.

FIG. 11 is a block diagram of a computing device that can be used in the various embodiments.

### DETAILED DESCRIPTION

### 1. Introduction

Protocols for assessing FHB resistance have conventionally relied upon the trained eye. The severity of FHB in wheat was accurately scored by counting infected spikelets and expressing that as a percentage of total spikelets. Nevertheless, this approach is laborious, costly, time-consuming, and subject to human error. The spectral sensor can intelligently perceive the spectral characteristics of an object at a certain point but cannot obtain a macroscopic image of the identified object. Thus, there is an urgent need to develop a more effective and high-throughput approach for assessing this disease in the field. Computer vision-based phenotyping is a rapid, high-throughput, and non-destructive technique for capturing many types of traits. Imaging techniques such as hyperspectral imaging (HSI), and red—green—blue (RGB) imaging, have been widely used to study the complex traits associated with plant growth, biomass, yield, and responses to biotic stresses such as disease and abiotic stresses such as cold, drought and salinity. With respect to FHB, Whetton et al. processed HSI images of infected and healthy crop canopies including wheat and barley under controlled environmental conditions. The correlations between FHB severity and HSI data were investigated for quantification of wheat resistance to FHB. Based on support vector machine (SVM) and fisher linear discriminant analysis, healthy and infected spikes were classified with acceptable accuracies (79-89%). The performance of the diagnosis model was then improved using a particle swarm optimization support vector machine (PSO-SVM). Relevance vector machine (RVM) performed better than the logistic model for prediction of FHB severity under natural environmental conditions. However, more advanced algorithms such as convolutional neural network (CNN) have not been adopted in their study. In addition, one big challenge faced by HSI technology is the difficulty for rapidly processing a large amount of high-dimensional data obtained in a continuous spectral range and to effectively execute automatic operations.

A color imaging camera with built-in RGB filters can rapidly capture RGB images through three spectral channels (red, green, and blue), and has great potential for real-time detection of wheat FHB. Although K-means clustering and random forest classifier have been used for segmentations of disease areas in wheat spikes, the advantage of this digital imaging technique is greater when a large number of datasets are available and a more powerful machine learning algorithm is utilized. Deep learning with great merit of automatic feature learning is a core part of the larger family of machine learning based on multiple layers of artificial neural networks, which allows greater learning capabilities and higher computational performance. As a widely recognized deep neural network, CNN has become a standard algorithm in object identification. Hasan et al. tested a faster region-based convolutional neural network (Faster R-CNN) model to detect wheat spikes and output a bounding box (bbox) for each spike. Deep convolutional neural network (DCNN) models were successfully used to localize wheat spikes under greenhouse conditions and predict the FHB disease severity with high accuracy. Zhang et al. developed a pulse-coupled neural network (PCNN) with K-means clustering of the improved artificial bee colony (IABC) for the segmentation of wheat spikes infected FHB. Since only one spike in each image was considered, it would be difficult to efficiently detect disease in a high throughput way. Then, Qiu et al. developed a protocol that can segment multiple spikes in an image and then used a region-growing algorithm to detect the diseased area on each wheat spike. However, conventional image processing operations including region-growing, gray-scale co-occurrence matrix, and connectivity analysis are not suitable for real-time disease detections. In addition, wheat spikes located at the image borders could not be segmented, and the accuracy of the target spike and disease area identifications was significantly reduced due to the presence of awns on the spike. In these studies, the shape or contour information was only roughly extracted; thus, it was difficult to accurately identify the targets. Such factors reduced the accurate assessment of FHB disease levels. Thus, a new strategy should be designed to reliably evaluate wheat resistance to Fusarium head blight under field conditions. Mask region convolutional neural network (Mask-RCNN) is a machine vision based deep structural learning algorithm to directly solve the problem of instance segmentation. This algorithm has been successfully employed to identify fruits and plants. For instance, Ganesh et al. and Jia et al. developed harvesting detectors based on the Mask-RCNN for robotic detections of apple and orange in orchards with precision of 0.895 to 0.975. Yang et al. revealed the potential of Mask-RCNN for the identification of leaves in plant images for rapid phenotype analysis, yielding the average accuracy value up to 91.5%. Tian et al. illustrated that Mask-RCNN performed best compared to other models including CNN and SVM in automatic segmentation of apple flowers of different growth stages.

The novelty of this embodiment is in the development of an integrated approach for FHB severity assessment based on Mask-RCNN for high-throughput wheat spike recognition and precision FHB infection segmentation under complex field conditions. The Mask-RCNN combined object detection and instance segmentation provide an efficient framework to extract object bboxes, masks, and key points. The main objective of this research is to determine the performance of Mask-RCNN based dual deep learning frameworks for real-time assessments of wheat for FHB severity in field trials. The specific objectives were to: (1) develop an imaging protocol for capturing quality images of wheat spikes in the field; (2) annotate spikes and diseased spikelets in the images; (3) build a Mask-RCNN model that works well in detecting and segmenting wheat spikes under complex backgrounds; (4) develop a second Mask-RCNN model that is valuable for prediction of diseased areas in individual spikes of segmented sub-images; (5) evaluate the disease grade of wheat FHB based on the ratio of the disease area to the entire wheat spike. We believe this is the first system using dual Mask-RCNN frameworks for automatic evaluation of wheat FHB disease severity.

### 2. Materials and Methods

### 2.1. Data Collection

FHB evaluation trials were established at the Minnesota Agricultural Experiment Station on the Saint Paul campus of the University of Minnesota. Wheat samples of 55 genetic lines were sown on May 2019 and FHB inoculations were made using the conidial spray inoculation. To achieve sufficient infection levels on wheat lines throughout the field nursery, three inoculations were made: the first performed one week before the heading time of the earliest maturing accessions, the second one week later, and the third coinciding with accessions having late heading dates. Daily mist irrigation (0.61 cm per day) was provided at regular intervals (10 min at the top of every hour, 0.05 cm per hour) from 6 p.m. through 5 a.m. (12 times) to promote infection and disease development. Irrigation began after the first inoculation and continued until the latest maturing accessions reached the late dough stage of development. The growth stage of wheat at the time of image acquisition is a key factor for effective FHB detection. When the wheat was in the start of flowering and the late maturing stage, distinction of diseased spikes was not possible based on the naked eye. The best time to assess the disease is when the spike symptoms become visible but not yet senescence.

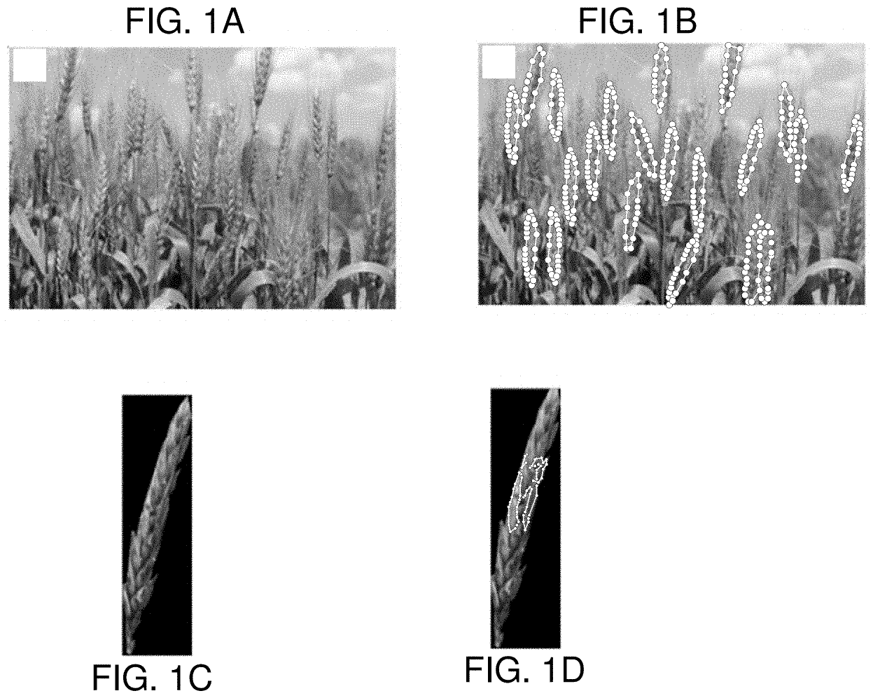

An autofocus single-lens reflex (SLR) camera (Canon EOS Rebel T7i, Canon Inc., Tokyo, Japan) mounted with a fixed macro lens was utilized to acquire images. The camera ran in automatic mode, allowing it to set the appropriate acquisition parameters including white balance, ISO speed and exposure time. Images of wheat spikes of 55 genetic lines at the late flowering stage to the milk stage of maturity (from July 11 to August 2) were eventually collected during sunny weather (10:00 to 13:00) in the field. Different genetic lines of wheats had different resistance to FHB. The images obtained contained FHB of 15 severity stages from grade 0 to grade 14 (Grade 0: [0-1%], Grade 1: (1-2.5%], Grade 2: (2.5-5%], Grade 3: (5-7.5%], Grade 4: (7.5-10%], Grade 5: (10-12.5%], Grade 6: (12.5-15%], Grade 7: (15-17.5%], Grade 8: (17.5-20%], Grade 9: (20-25%], Grade 10: (25-30%], Grade 11: (30-40%], Grade 12: (40-50%], Grade 13: (50-60%], Grade 14: (60-100%]). Images were captured under the ambient conditions of the field site, which included complex and variable backgrounds of blue sky, white clouds, and green wheat plants. Each image (resolution: 6000×4000) contained about 7-124 spikes (FIG. 1A).

### 2.2 Data Annotation and Examination

Wheat spikes and diseased areas in collected images were manually annotated. A total of 690 images were captured from a large wheat germplasm collection that varied with respect to FHB reaction. Among this set, 524 images (including 12,591 spikes) and 166 images (including 4749 spikes) were randomly selected as the training set and the validation set of the model for spike identifications, respectively. For disease area detection, 2832 and 922 diseased spikes in sub-images were used, respectively, for model training and validation by random selection. All image annotations were executed by using an artificial image annotation software (Labelme, https://github.com/wkentaro/labelme). Three steps were used for image annotation. The first step was to label wheat spikes in the original images (FIG. 1B); the second step was to segment annotated spikes into different sub-images, and the third step was to label the diseased areas in each individual spike. Specifically, the shapes of wheat spikes in the full-size image in the training set were marked by manually drawing polygons. Each of the labeled spikes was then automatically segmented into a sub-image containing a single spike by image processing. All areas of the sub-image were first defaulted as the background (black color) using binarization; then, only the annotated areas were allowed to be recovered (FIG. 1C). The physical feature of the diseased areas on the spike of the sub-image was labeled manually (FIG. 1D).

### 2.3 Mask-RCNN

Mask-RCNN was employed to automatically segment the diseased areas of the wheat spikes in full-size images. It is a two-stage model for object detection and segmentation. The first stage is the regional proposal network (RPN), which aims to propose candidate bboxes in the regions of interest (RoI). The second stage is based on the normalized RoIs acquired from RoI Align to output confidence, bbox, and binary mask. The Mask-RCNN is mainly composed of four parts including a backbone, feature pyramid network (FPN), RPN, and feature branches. The backbone is a multilayer neural network used to extract feature maps of original images. A backbone network can be any CNN with residual network (ResNet) developed for image analysis. It relies on a series of stacked residual units as a set of building blocks to develop the network-in-network architecture. The residual units consist of convolution, pooling, and layers.

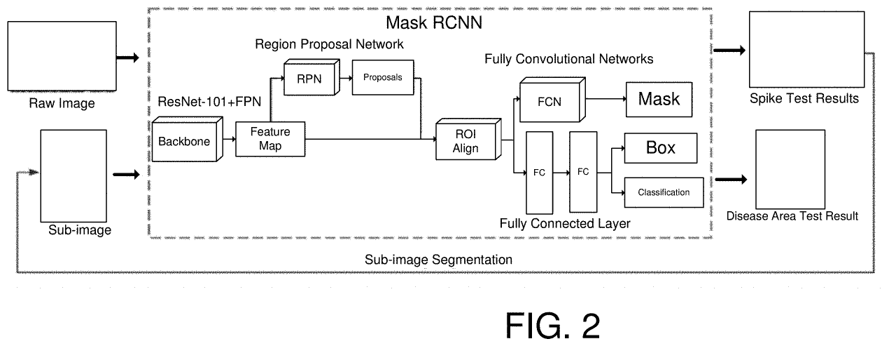

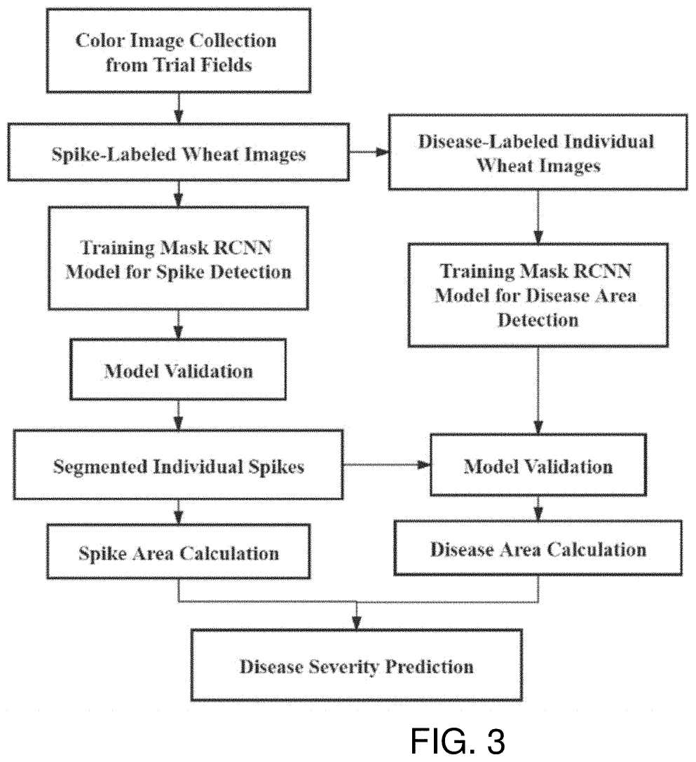

A ResNet model with 101 layers (ResNet-101) was employed in this embodiment. The purpose of using FPN is to completely extract multi-scale feature maps. The RPN has the capacity to generate and choose a rough detection rectangle. Based on functional branches, three operations in terms of classification, detection, and segmentation can be performed. In addition, the batch normalization (BN) is added between activation functions and convolutional layers in the network to accelerate the convergence speed of network training. The original full-size images with annotated wheat spikes and the sub-images with annotated diseased areas were used, respectively, as the inputs to train two Mask-RCNN models for detection of wheat spikes and diseased areas. Based on the trained dual models, the segmentation of wheat spikes and FHB diseased areas of the images in the validation set was conducted (FIG. 2). The severity of FHB was examined based on the ratio of the number of pixels of diseased area to the number of pixels of entire spike area. The workflow of this study is presented in FIG. 3.

### 2.4. Evaluation Metrics

The performance of the Mask-RCNN was evaluated using several parameters. The false positive (FP), false negative (FN), and true positive (TP) were computed and used to generate metrics including recall, precision, F1-score, and average precision (AP). Among them, the recall (also known as sensitivity) is the proportion of the number of real positive instances in the total number of instances actually belonging to the positive category, while precision (also known as positive predictive value) is the proportion of the number of real positive instances among the total number of instances predicted as belonging to the positive category. As a measure of accuracy of the test, the F1-score (also F-measure) is the harmonic mean of the recall and precision, where parameters are evenly weighted. The AP is the area under the precision— recall (PR) curve. The AP score is computed as the mean precision over 11 recall values (default values) given a preset intersection over union (IoU) threshold. The IoU is defined as the degree to which the manually labeled ground truth box overlaps the bbox generated by the model. The mean intersection over union (MIoU) is a standard indicator for assessing the performance of image segmentation. MIoU was computed as the number of TP over the sum of TP, FN, and FP. The precision, recall, F1-score, AP, IoU, and MIoU can be expressed by the following equations:

$$precision = \frac{TP}{TP + {FP}^{′}} \qquad ( 1 )$$

$$recall = \frac{TP}{TP + {FN}^{′}} \qquad ( 2 )$$

$$F 1 = \frac{2 PR}{P + {R}^{′}} \qquad ( 3 )$$

$$AP = \frac{1}{11} {\sum }_{{R}_{j}} P ( {R}_{j} ) , j = 1 , 2 , 3 … , 11 \qquad ( 4 )$$

$$IoU ( E , F ) = \vert \frac{E ⋂ F}{E ⋃ F} \vert , \qquad ( 5 )$$

$$MIoU = \frac{1}{k + 1} {\sum }_{i = 0}^{k} \frac{{P}_{ii}}{{\sum }_{j = 0}^{k} {P}_{ij} + {\sum }_{j = 0}^{k} {P}_{ji} - {P}_{ii}^{′}} \qquad ( 6 )$$

where TP corresponds to the number of true positives generated (i.e., the number of wheat spikes correctly detected), FP represents the number of wheat spikes incorrectly identified, FN is the number of wheat spikes undetected but should have been identified. E represents the ground truth box labeled manually and F represents the bbox generated based on the Mask-RCNN model. If the estimated IoU value is higher than the preset threshold (0.5), the predicted result of this model is considered as a TP, otherwise as an FP. k+1 is the total number of output classes including an empty class (the background), and Pᵢᵢ represents TP, while Pᵢⱼ and Pⱼᵢ indicate FP and FN, respectively.

### 2.5. Equipment

The entire process for model training and validation was implemented by a personal computer (processor: Intel(R) Xeon(R) CPU E3-1225 v3 @ 3.20 GHz; operating system: Ubuntu 18.04, 64 bits; memory: 20 Gb). The training speed was optimized in graphics processing unit (GPU) mode (NVIDIA RTX 2070 8 Gb). Table 1 presents the relevant modeling parameters (such as the base learning rate) adopted in this study. The time for model training and validation is shown in Table 2. The code for image processing was written in Python.

TABLE 1
Modeling parameter settings.

| Modelling Parameters | Values |
|---|---|
| Based learning rate | 0.02 |
| Image input batch size | 2 |
| Gamma | 0.1 |
| Number of classes | 2 |
| Maximum iterations | 2,700,000 |

TABLE 2
The total time for model training and validation

| Application | Training Time | Validation Time |
|---|---|---|
| Wheat spike | 45 h 23 min 26 s | 16 min 30 s |
| identification | | |
| FHB disease | 23 h 46 min 58 s | 1 min 28 s |
| detection | | |

### 3. Results

### 3.1. Model Training

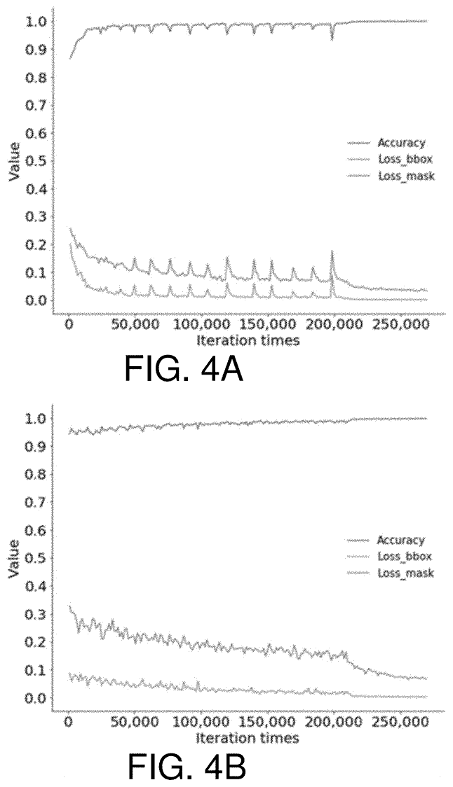

Dual training Mask-RCNN models of deep neural networks were established based on the annotated images of wheat spikes and FHB diseased areas. FIG. 4A shows the trend of accuracy and loss during first model training for wheat spike identification. It was observed that the loss of the bbox and the mask dropped sharply from the initial iteration and tended to stabilize after 25,000 iterations. Compared with the loss, the model accuracy increased during this process. The function curves of the accuracy and the loss fluctuated during the iterations and weakened after iterating 210,000 times. Both the accuracy function and the loss functions reached convergence after 270,000 iterations. As can be seen, the loss value of the mask was always greater than that of the bbox. When the model accuracy for wheat spike increased to 1 (100%), the loss value of the bbox reached the lowest (0.001), and the loss value of the mask reduced to 0.037. Similarly, FIG. 4B describes the variation of the accuracy and the loss in another model training for FHB disease assessment. Throughout the iteration process, both the loss values of the bbox and the mask gradually decreased and tended to converge, while the model accuracy maintained a trend of weak growth until convergence. Eventually, the loss values of the mask and the bbox reduced to 0.063 and 0.002, respectively, while the model accuracy for diseased areas increased to over 99.80%. These results indicate that the trained classifiers effectively learned the features of annotated wheat spikes and diseased areas.

### 3.2. Wheat Spike Identification

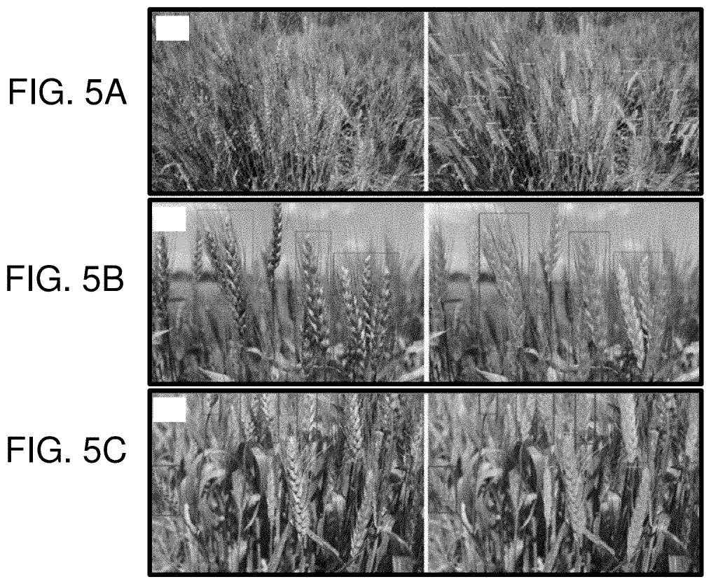

The trained Mask-RCNN model was then used to recognize wheat spikes in full-size images in the validation set. Instance segmentation of individual wheat spikes was conducted under complex conditions including occlusion and overlap. The category score (bbox) and mask of each wheat spike was generated for the test images. The algorithm successfully recognized the high-density wheat spikes in the field (FIG. 5A). Due to the camera shooting angle, wheat spikes in the images inevitably obstructed each other, but the algorithm was able to segment two wheat spikes with overlapping boundaries (FIG. 5B). Most FHB phenotyping was only taken from plants in the center portion of a plot and the edge of plots were excluded due to possible edge effects, which meant wheat spikes that were incompletely segmented were usually located at the borders of full-size images. FIG. 5C shows that the wheat spikes cut at the image borders are able to be successfully recognized. It is important to identify the partial spikes because such spikes can be used as a beneficial supplement to maximize the dataset and enhance the robustness of the model. The segmentation results of 166 test images showed that the MIoU rate for wheat spikes reached 52.49%. The algorithm presented an acceptable performance for wheat spike prediction, with the AP of the mask and the bbox of 57.16% and 56.69%, respectively (Table 3). Based on the results of 166 images, the overall rates of precision, recall, IoU and F1-score were 81.52%, 71.00%, 46.41% and 74.78%, respectively. The total number of spikes identified by the Mask-RCNN was compared with the actual number of spikes labeled manually. Among 4749 wheat spikes, 3693 spikes were correctly identified, yielding the recognition rate of 77.76%. This proves that the Mask-RCNN was effective for rapidly identifying wheat spikes under field conditions.

TABLE 3
Results of Mask-RCNN for wheat spike and
Fusarium head blight (FHB) disease detecition.

| | | | F1-Score | IoU | AP of | AP of | MIoU |
|---|---|---|---|---|---|---|---|
| Type | P (%) | R (%) | (%) | (%) | Bbox(%) | Mask (%) | (%) |
| Wheat spike | 81.52 | 71.00 | 74.78 | 46.41 | 56.69 | 57.16 | 52.49 |
| FHB disease | 72.10 | 76.16 | 74.04 | 51.24 | 63.38 | 65.14 | 51.18 |

### 3.3 FHB Disease Evaluation

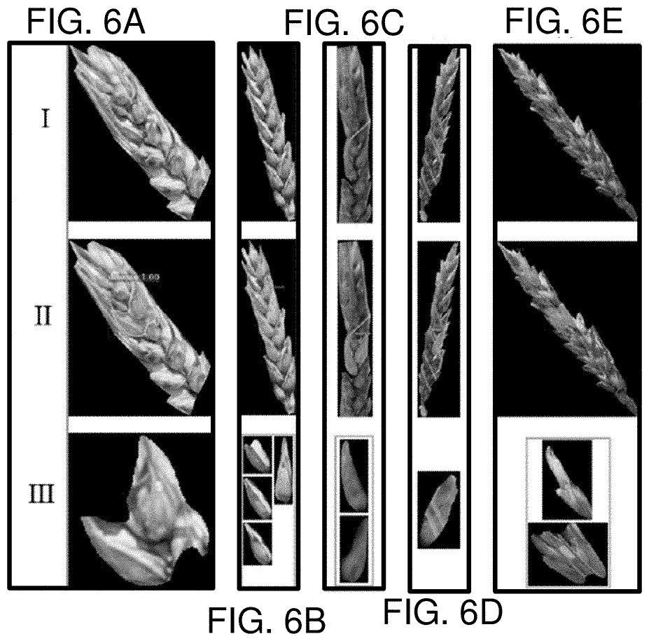

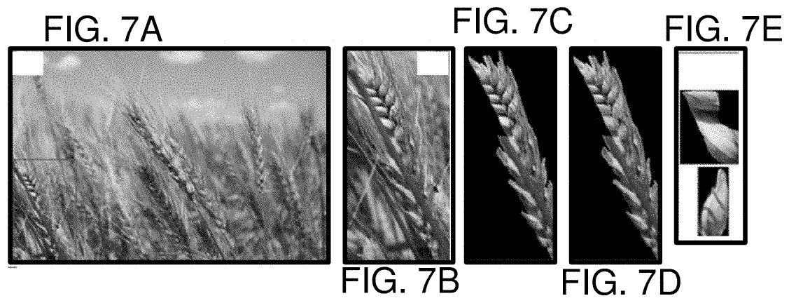

After segmenting the individual wheat spikes in full-size images, a second trained Mask-RCNN model was employed to evaluate the diseased areas on these infected spikes. A dataset of 922 sub-images of diseased wheat spikes was used as the validation set in Mask-RCNN. As shown in row I of FIGS. 6A, 6B, 6C, 6D and 6E, each sub-image contained one spike. The diseased spikelets in each spike were successfully recognized and marked using the category scores, bboxes, and masks (row II of FIGS. 6A, 6B, 6C, 6D and 6E). The instance area of FHB disease can be segmented and extracted. Row III of FIGS. 6A, 6B, 6C, 6D and 6E shows the segmentation images of infected spikelets from the spikes. Results showed that the MIoU rate for disease area instance segmentation reached 51.18%. The AP rates of the mask and the bbox for FHB disease detection were 65.14% and 63.38%, respectively. The diseased areas with shadow, strong light, low light, or awn occlusion were effectively recognized (FIGS. 6A, 6B, 6C, 6D and 6E). FIGS. 7A, 7B, 7C, 7D and 7E shows the results for disease detection when the entire wheat spike is occluded by a straw. Mask-RCNN achieved the accurate identification of diseased areas. Eventually, a total of 911 diseased spikes were recognized from 922 samples with the detection rate of 98.81%. Moreover, Mask-RCNN generated acceptable results for detecting disease, yielding the overall rates of precision, recall, F1-score, and IoU of 72.10%, 76.16%, 74.04% and 51.24%, respectively (Table 3).

### 3.4 Examination of Wheat FHB Severity

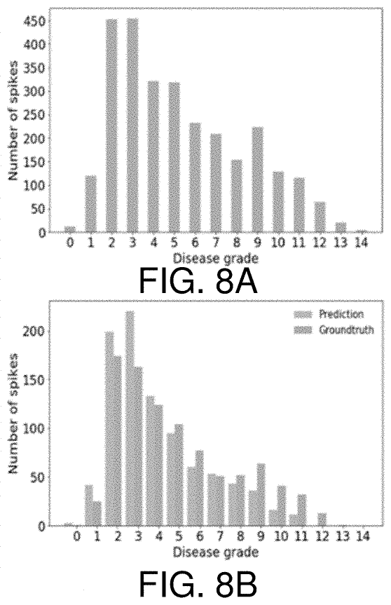

The FHB disease severity was evaluated according to the ratio of the disease area to the entire spike area. As shown in FIGS. 8A and 8B, disease levels of each spike were calculated and divided into 14 FHB severity grades. Spikes with lower disease levels were separated into more numerous grades with narrower severity intervals, because selecting among lines with lower disease levels is more critical to the breeding process, as lines with high disease levels are undesirable. FIG. 8A depicts the ground truth (ground truth is the visual rating of spikes by an expert from the acquired images) of wheat spikes at different disease grades in the training set. As seen in FIG. 8A, 83.51% of samples in the training set were categorized with disease grades of 2-9, while 87.74% of the ground truth in the validation set was assigned to this group, which was a little bit lower than that (92.10%) in the prediction set as described in FIG. 8B. The statistical results of the FHB severity of wheat spikes in the training and validation sets are shown in Table 4. By inspecting the distribution of samples, it was observed that the ground truth of FHB severity in the validation set was close to that of the training set. The overall predicted ratio of the disease area over the entire spike area was 9.27% (grade 4) based on data in validation set. For 92.10% of wheat spikes, the infected area of an individual spike ranged from 2.5% to 25% (grades 2-9). Samples with infection areas of 2.5% to 10% (grades 2-4) accounted for 60.59%, followed by the 27.55% samples with the infection area between 10% and 20% (grades 5-9). When the disease level was over grade 4, it was observed that the predicted number (e.g., 95 for grade 5) of the diseased wheat spikes in each grade was lower than the ground truth (e.g., 105 for grade 5). In disease grades 5-12, the differences between blue bars and orange bars are the false negatives. When the disease level was no more than grade 4, the predicted number (e.g., 133 for grade 4) of spikes in each grade was higher than its actual number (e.g., 124 for grade 4). These differences in categories (1-4) are the false positives. Nevertheless, the average disease severity (9.27%) from the prediction was comparable to that of the ground truth (12.01%). Eventually, the prediction accuracy (77.19%) for diseased wheat spikes was calculated by the severity value of prediction (9.27%) over ground truth (12.01%).

TABLE 4
Statistical results of wheat spike FHB disease severity.

| | | No. of | Severity (%) | | |
|---|---|---|---|---|---|
| Dataset | Type | Spikes | Mean ± SD | Max | Min |
| Training | Ground | 2382 | 13.23 ± | 85.51 | 0.50 |
| | truth | | 10.44 | | |
| Validation | Ground | 922 | 12.01 ± | 50.16 | 0.89 |
| | truth | | 8.81 | | |
| | Prediction | 911 | 9.27 ± | 34.68 | 0.86 |
| | | | 6.15 | | |

The Mask-RCNN used in our study performed very well yielding the detection rate as high as 98.81% compared to the study of Williams et al., in which they reported a detection rate of 89.6% using CNN for kiwifruit. There are two main factors that led to the success of the current study. The first reason is the superiority of Mask-RCNN over CNN. Another main reason is probably because each wheat spike used to develop the training model is labeled with high precision, so that the performance and robustness of the trained Mask-RCNN model have been significantly improved. This algorithm for wheat spike detection showed a similar performance to the PCNN in eliminating background interference. Mask-RCNN has the capability of providing segmentation masks for rapid detection of multiple wheat spikes (7-124) in one image, which is more feasible for a high-throughput and real-time assay in the field.

### 5. Conclusions

A high-throughput framework of deep-learning based disease detection algorithms was established to automatically assess wheat resistance to FHB under field conditions. The protocols involved image collection, processing and deep learning modeling. Dual Mask-RCNN models were developed for rapid segmentations of wheat spikes and FHB diseased areas. Based on the methodology, mask images of individual wheat spikes and diseased areas were outputted, with detection rates of 77.76% and 98.81%, respectively. The Mask-RCNN model demonstrated strong capacity for recognition of the targets occluded by wheat awns or cut at the image borders. By calculating the wheat FHB severity value of prediction over ground truth, acceptable prediction accuracy was achieved. The knowledge generated by this study will greatly aid in the efficient selection of FHB resistant wheat lines in breeding nurseries. This, in turn, will contribute to the development of resistant wheat cultivars that will ameliorate the losses due to FHB, thereby contributing to global food security and sustainable agricultural development.

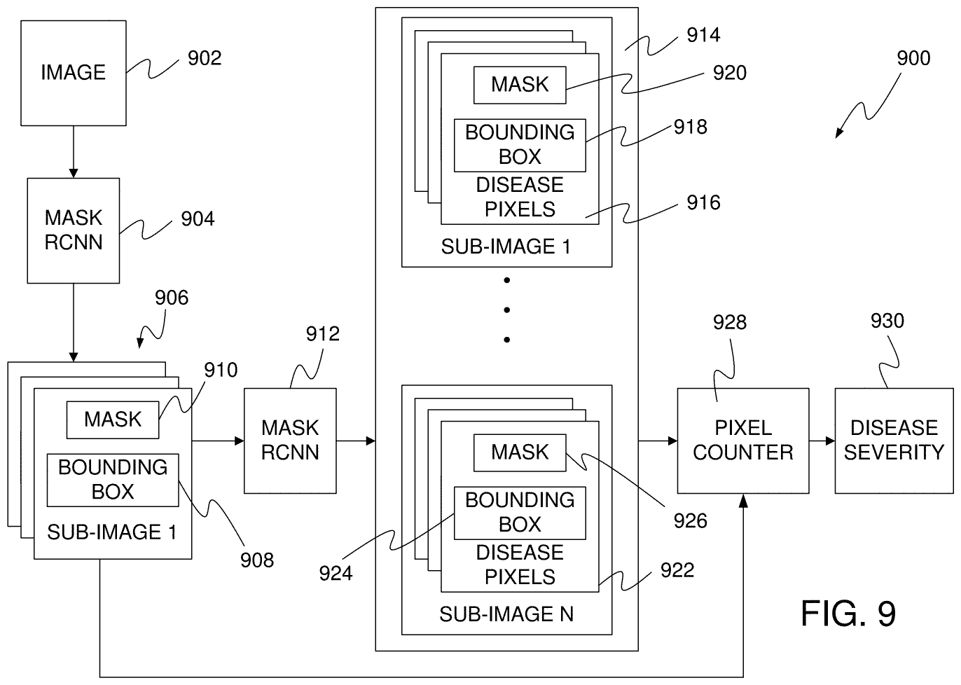

FIG. 9 provides a block diagram of a system 900 in accordance with one embodiment. In FIG. 9, an image of a field 902 is provided to a Mask-RCNN 904. In accordance with one embodiment, image 902 contains a plurality of wheat spikes and is taken in a natural setting without artificial backdrops or lighting.

Mask-RCNN 904 is trained to segment individual wheat spikes from the remainder of image 902. Mask-RCNN 904 generates a plurality of sub-images 906 that each include a single wheat spike segmented from other wheat spikes in image 902. In accordance with one embodiment, each sub-image includes the location and dimensions of a bounding box that surrounds the wheat spike. The location and dimensions are provided in terms of pixel coordinates of image 902. For example, for a 6000×4000 image, if the pixel in the lower left corner of the image is set as pixel origin 0,0, the pixel at the upper left corner would be at pixel coordinate 0,4000, the pixel at the lower right corner would be at pixel coordinate 6000,0 and the pixel at the upper right corner would be at pixel coordinate 6000,4000. The location of the bounding box is the pixel coordinate of the lower-left corner of the bounding box, and the dimensions of the bounding box are the pixel height and pixel width of the bounding box. In FIG. 9, sub-image 1 includes the location and dimensions of a bounding box 908.

Each sub-image created by Mask-RCNN 904 also includes a mask which consists of the coordinates of pixels in image 902 that define the outer contour of the wheat spike. In some embodiments, the mask may include the coordinates of all pixels that represent a part of the wheat spike. For example, sub-image 1 of FIG. 9 includes mask 910.

The plurality of sub-images are provided, one at a time, to a second Mask-RCNN 912, which identifies a collection of disease pixels 914 present in the sub-images. Specifically, for each sub-image, Mask-RCNN 912 identifies zero or more disease pixel sets, such as disease pixel set 916 for sub-image 1 and disease pixel set 922 for sub-image N. Each disease pixel set is defined by the location and dimensions of a bounding box that surrounds the disease pixels, such as bounding box 918 and bounding box 924. In addition, each disease pixel set is further defined by a mask consisting of pixels in the sub-image that define the outer perimeter of a diseased area on the wheat spike. In other embodiments, the mask includes a list of all pixels in the sub-image that form this disease pixel set. In FIG. 9, disease pixel set 916 is shown to include mask 920 and disease pixel set 922 is shown to include mask 926.

The disease pixels sets for each sub-image are provided to a pixel counter module 928, which counts the pixels in each mask of each disease pixel set to produce a disease pixel count representing the number of pixels that depict a diseased portion of a wheat spike in image 902. In addition, pixel counter module 928 counts the number of pixels that are in each mask produced by first Mask-RCNN 904, such as mask 920, to produce a wheat spike pixel count representing the number of pixels that depict a wheat spike in image 902. A disease severity module 930 uses the disease pixel count and the wheat spike pixel count to determine a disease severity. In accordance with one embodiment, the disease severity is determined as the ratio of the disease pixel count to the wheat spike pixel count.

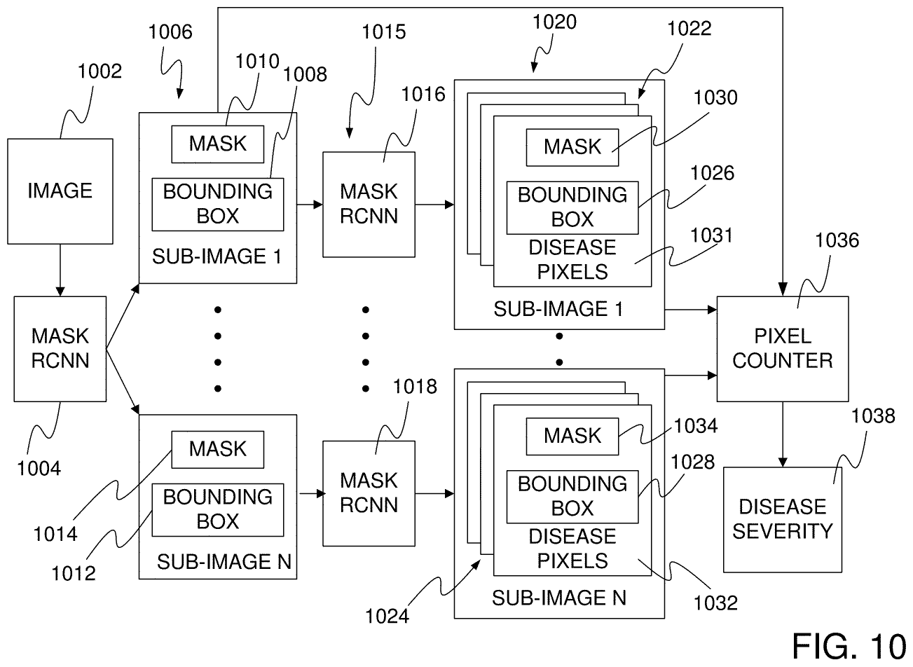

FIG. 10 provides a block diagram of a system 1000 in accordance with a second embodiment. In FIG. 10, an image of a field 1002 is provided to a Mask-RCNN 1004. In accordance with one embodiment, image 1002 contains a plurality of wheat spikes and is taken in a natural setting without artificial backdrops or lighting.

Mask-RCNN 1004 is trained to segment individual wheat spikes from the remainder of image 1002. Mask-0RCNN 1004 generates a plurality (N) of sub-images 1006 that each include a single wheat spike segmented from other wheat spikes in image 1002. In accordance with one embodiment, each sub-image includes the location and dimensions of a bounding box that surrounds the wheat spike, wherein the location and dimensions are provided in terms of pixel coordinates of image 1002. In FIG. 10, sub-image 1 includes the location and dimensions of a bounding box 1008 and sub-image N includes the location and dimensions of a bounding box 1012.

Each sub-image created by Mask-RCNN 1004 also includes a mask which consists of the coordinates of pixels in image 1002 that define the outer contour of the wheat spike. In some embodiments, the mask may include the coordinates of all pixels that represent a part of the wheat spike. For example, sub-image 1 of FIG. 10 includes mask 1010 and sub-image N includes a mask 1014.

Each of the plurality of sub-images 1006 is provided to a respective Mask-RCNN of a set of Mask-RCNNs 1015 that operate in parallel. For example, sub-image 1 is provided to Mask-RCNN 1016 while sub-image N is provided to Mask-RCNN 1018. By operating the Mask-RCNNs 1015 in parallel, the disease pixels for the different sub-images can be determined at the same time thereby reducing the amount of time needed to determine the level of disease in the field. Thus, the embodiment of FIG. 10 provides an improvement to a computer system.

Each Mask-RCNN of Mask-RCNNs 1015 produces zero or more disease pixel sets for the sub-image provided to the Mask-RCNN. For example, Mask-RCNN 1016 produces disease pixel set 1022 for sub-image 1 while Mask-RCNN 1018 produces disease pixel set 1024 for sub-image N. Together, the disease pixel sets form a collection of disease pixels 1020.

Each disease pixel set is defined by the location and dimensions of a bounding box that surrounds the disease pixels, such as bounding box 1026 and bounding box 1028. In addition, each disease pixel set is further defined by a mask consisting of pixels in the sub-image that define the outer perimeter of a diseased area on the wheat spike. In other embodiments, the mask includes a list of all pixels in the sub-image that form this disease pixel set. In FIG. 10, disease pixel set 1031 is shown to include mask 1030 and disease pixel set 1032 is shown to include mask 1034.

The disease pixel sets for each sub-image are provided to a pixel counter module 1036, which counts the pixels in each mask of each disease pixel set to produce a disease pixel count representing the number of pixels that depict a diseased portion of a wheat spike in image 1002. In addition, pixel counter module 1036 counts the number of pixels that are in each mask produced by first Mask-RCNN 1004, such as mask 1010, to produce a wheat spike pixel count representing the number of pixels that depict a wheat spike in image 1002. A disease severity module 1038 uses the disease pixel count and the wheat spike pixel count to determine a disease severity. In accordance with one embodiment, the disease severity is determined as the ratio of the disease pixel count to the wheat spike pixel count.

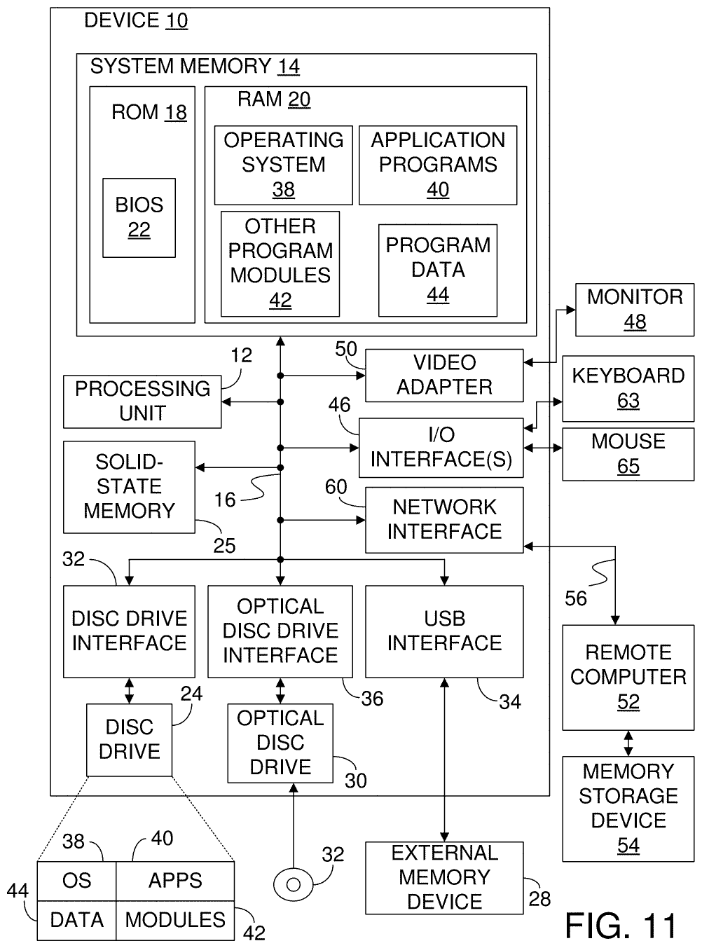

FIG. 11 provides an example of a computing device 10 that can be used to execute the Mask-RCNNs, pixel counters and disease severity module discussed above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes an optional hard disc drive 24, an optional external memory device 28, and an optional optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of modules discussed above. Program data 44 may include any data used by the systems and methods discussed above.

Processing unit 12, also referred to as a processor, executes programs in system memory 14 and solid state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 11. The network connections depicted in FIG. 11 include a local area network (LAN) or wide area network(WAN) 56. Such network environments are commonplace in the art. The computing device 10 is connected to the network through a network interface 60.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 11 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A method comprising:
applying an image containing a plurality of wheat spikes to a trained neural network to produce a plurality of sub-images, each sub-image comprising a respective single wheat spike segmented from other wheat spikes of the plurality of wheat spikes; and
applying each sub-image to a second trained neural network to produce at least one disease pixel set, wherein each disease pixel set consists of pixels depicting a diseased portion of a wheat spike.

2. The method of claim 1 wherein the trained neural network comprises a Mask-RCNN.

3. The method of claim 2 wherein the second trained neural network comprises a second Mask-RCNN.

4. The method of claim 1 further comprising counting the number of pixels in the disease pixel sets produced for a sub-image to determine a level of disease in the wheat spike.

5. The method of claim 4 further comprising counting the number of pixels in the wheat spike of the sub-image and using a ratio of the number of pixels in the disease pixel set to the number of pixels in the wheat spike of the sub-image to determine the level of disease in the wheat spike.

6. The method of claim 1 wherein the second trained neural network is trained using a training image of a wheat spike within a bounding box, wherein pixels in the bounding box that are not part of the wheat spike are set to a same color.

7. The method of claim 6 wherein the second trained neural network is further trained using pixel labels that label each pixel of the wheat spike as either diseased or not diseased.

8. A system comprising:
a processor executing a first neural network that receives an image of a field and produces a plurality of sub-images, each sub-image providing a respective wheat spike in isolation; and
at least one processor executing a second neural network that receives a sub-image and identifies pixels in the sub-image that represent diseased portions of the wheat spike in the sub-image.

9. The system of claim 8 wherein each sub-image comprises a bounding box and a mask, wherein the mask designates pixels that depict the wheat spike.

10. The system of claim 9 wherein the first neural network comprises a Mask-RCNN.

11. The system of claim 8 wherein each sub-image produced by the first neural network is applied to the second neural network.

12. The system of claim 8 wherein the at least one processor comprises two processors executing in parallel such that a first sub-image produced by the first neural network is applied to one of the two processors executing the second neural network while a second sub-image produced by the first neural network is applied to the other of the two processors executing the second neural network.

13. The system of claim 8 further comprising counting a number of pixels in the wheat spike in isolation as part of determining a level of disease in the wheat spike.

14. The system of claim 13 further comprising counting a number of identified pixels in the sub-image that represent diseased portions of the wheat spike as part of determining the level of disease in the wheat spike.

15. A method comprising:
segmenting wheat spikes in an image to form a plurality of sub-images; and
applying each sub-image to a deep learning system to identify pixels in the sub-image that depict a diseased area of the wheat spike; and
using the identified pixels to produce a measure of disease in wheat spikes contained in the image.

16. The method of claim 15 wherein segmenting the wheat spikes comprises applying the image to a deep learning system.

17. The method of claim 16 wherein applying the image to a deep learning system comprises applying the image to a Mask-RCNN.

18. The method of claim 17 wherein the Mask-RCNN produces a bounding box and a mask for each sub-image.

19. The method of claim 15 wherein producing a measure of disease in the wheat spikes comprises counting a number of pixels in each mask.

20. The method of claim 19 wherein applying each sub-image to a deep learning system comprises applying each sub-image to a Mask-RCNN.
